(19) United States
(12) Patent Application Publication
(10) Pub. No.: US 2015/0268846 A1
(43) Pub. Date: Sep. 24, 2015

(54) Method And Device For Adjusting Application Scenario Parameters

(71) Applicants: Hisense Co.,Ltd., Qingdao (CN); HISENSE USA CORPORATION, Suwanee, GA (US); Hisense International Co.,Ltd., Qingdao (CN)

(72) Inventor: Tongqing GAO, Qingdao (CN)

(21) Appl. No.: 14/663,554

(22) Filed: Mar. 20, 2015

(30) Foreign Application Priority Data
Mar. 21, 2014 (CN) 201410108795.8

(51) Int. Cl. G06F 3/0484

(52) U.S. Cl. CPC G06F 3/04847; G06F 3/04842

(57) ABSTRACT

The disclosure discloses a method and device for adjusting application scenario parameters, where a play device determines an application scenario corresponding to contents to be displayed; determines application scenario parameters of the contents to be displayed, corresponding to the application scenario of the contents to be displayed according to a correspondence relationship between the application scenario, and the application scenario parameters, of the contents to be displayed; and transmits the determined application scenario parameters of the contents to be played, to the display device over a network channel between the play device and the display device, and the display device adjusts application scenario parameters according to the received application scenario parameters to replace the current scenario parameters, so that the display device can set different application scenario parameters for different playing contents.

### CROSS-REFERENCE TO RELATED APPLICATION

This application claims the benefit and priority of Chinese Patent Application No. 201410108795.8 filed Mar. 21, 2014. The entire disclosure of the above application is incorporated herein by reference.

### FIELD

The disclosure relates to the field of video technologies and particularly to a method and device for adjusting application scenario parameters.

### BACKGROUND

This section provides background information related to the present disclosure which is not necessarily prior art.

At present, a video being displayed may not be limited to being displayed on a display device but has been displayed on separate devices in a variety of manners. The separate devices (e.g., a tablet PC and a TV set) are generally connected physically for communication to deliver a video signal between the devices commonly connected via a High Definition Multimedia Interface (HDMI), 3RCA, terminals, etc.

When a play device is separated from a display device, particularly for the display device, e.g., when a TV set switches a moving picture currently being played to a still picture, the still picture displayed on the TV set will be distorted to some extent, thus resulting in a low quality of the still picture being played on the TV set, but this problem has not been addressed for the existing separate display device.

### SUMMARY

This section provides a general summary of the disclosure, and is not a comprehensive disclosure of its full scope or all of its features.

An embodiment of the disclosure provides a method for adjusting application scenario parameters, the method including:

determining, by a play device, an application scenario corresponding to contents to be displayed;

determining, by the play device, according to a correspondence relationship between the application scenario of the contents to be displayed and application scenario parameters of the contents to be displayed, the application scenario parameters of the contents to be displayed; and

transmitting, by the play device, the determined application scenario parameters of the contents to be displayed, to a display device, so that the display device adjusts application scenario parameters according to the application scenario parameters of the contents to be displayed.

An embodiment of the disclosure provides another method for adjusting application scenario parameters, the method including:

receiving, by a display device, application scenario parameters of contents to be displayed, transmitted from a play device; and

adjusting, by the display device, application scenario parameters according to the application scenario parameters of the contents to be displayed.

An embodiment of the disclosure provides a play device, the play device including:

one or more processors;

and

a memory;

wherein the memory stores one or more computer readable program codes that, when executed, cause the one or more processors to:

determine an application scenario corresponding to contents to be displayed;

determine according to a correspondence relationship between the application scenario of the contents to be displayed and application scenario parameters of the contents to be displayed, the application scenario parameters of the contents to be displayed; and

transmit the determined application scenario parameters of the contents to be displayed, to a display device, so that the display device adjusts application scenario parameters according to the application scenario parameters of the contents to be displayed.

An embodiment of the disclosure provides a display device, the device including:

one or more processors;

and

a memory;

wherein the memory stores one or more computer readable program codes that, when executed, cause the one or more processors to:

receive application scenario parameters of contents to be displayed, transmitted from a play device; and

adjust application scenario parameters according to the application scenario parameters of the contents to be displayed.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 illustrates a flow chart of a method for adjusting application scenario parameters according to an embodiment of the disclosure;

FIG. 2 illustrates a flow chart of a method for adjusting application scenario parameters according to an embodiment of the disclosure;

FIG. 3 illustrates a flow chart of exchanging information over a control channel in a system for adjusting application scenario parameters according to an embodiment of the disclosure;

FIG. 4 illustrates a schematic structural diagram of a system for adjusting application scenario parameters according to an embodiment of the disclosure;

FIG. 5 illustrates a schematic structural diagram of another system for adjusting application scenario parameters according to an embodiment of the disclosure;

FIG. 6 illustrates a schematic structural diagram of a play device in a system for adjusting application scenario parameters according to an embodiment of the disclosure;

FIG. 7 illustrates a schematic structural diagram of a display device in a system for adjusting application scenario parameters according to an embodiment of the disclosure;

FIG. 8 illustrates a schematic structural diagram of another play device in a system for adjusting application scenario parameters according to an embodiment of the disclosure; and

FIG. 9 illustrates a schematic structural diagram of another display device in a system for adjusting application scenario parameters according to an embodiment of the disclosure.

### DETAILED DESCRIPTION

Example embodiments will now be described more fully with reference to the accompanying drawings.

In the embodiments of the disclosure, a play device determines an application scenario corresponding to contents to be displayed; determines application scenario parameters of the contents to be displayed, according to a correspondence relationship between the application scenario and the application scenario parameters of the contents to be displayed; and transmits the determined application scenario parameters of the contents to be displayed, to a display device over a network channel between the play device and the display device, and the display device adjusts application scenario parameters according to the received application scenario parameters to replace the current application scenario parameters, so that the display device can adjust different application scenario parameters for different playing contents to thereby greatly lower the distortion of a still picture while the playing contents are switched between a moving picture and the still picture so as to improve the quality of the different playing contents.

In order to make the technical problems to be addressed by and technical solutions and effects of the disclosure more apparent, the disclosure will be described below in further details with reference to the drawings and the embodiments thereof. It shall be appreciated that the particular embodiments described here are merely intended to illustrate but not limit the disclosure.

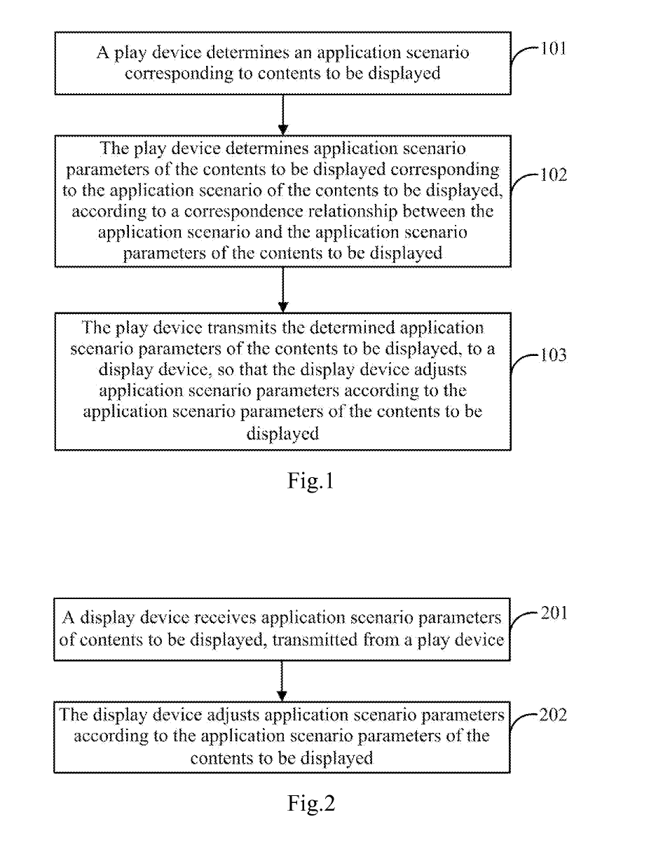

As illustrated in FIG. 1, a method for adjusting application scenario parameters according to a first embodiment of the disclosure includes the following operations:

Operation 101: a play device determines an application scenario corresponding to contents to be displayed;

Operation 102: the play device determines application scenario parameters of the contents to be displayed corresponding to the application scenario of the contents to be displayed, according to a correspondence relationship between the application scenario of the contents to be displayed, and the application scenario parameters of the contents to be displayed; and

Operation 103: the play device transmits the determined application scenario parameters of the contents to be displayed, to a display device, so that the display device adjusts application scenario parameters according to the application scenario parameters of the contents to be displayed.

In an embodiment of the disclosure, the contents to be displayed include but will not be limited to one of a video stored locally in the play device, a multimedia video from an external network, a webpage specified by a user, an interface specified by the user, a text file, etc.

In an embodiment of the disclosure, the contents to be displayed are available from an external network, a local storage of the play device, etc.

In an embodiment of the disclosure, the application scenario of the contents to be displayed falls into but will not be limited to a part or all of: a dynamic scenario for playing a video, a static scenario for displaying a webpage, a static scenario in which a user interface from an external network is displayed, a static scenario in which a text file is displayed, and a special scenario specified by a user, e.g., a child mode, a sports mode or another scenario.

In an embodiment of the disclosure, the application scenario can be modified and customized as needed for a user so that the play device can detect the application scenario corresponding to the contents to be displayed according to the contents. Particularly the user can modify and customize the corresponding application scenario according to program contents from a channel, for example, the user can set and save an application scenario corresponding to a program of a kids channel and an application scenario corresponding to a program of a sports channel; and particularly the user can also modify and customize the corresponding application scenarios according to a video, a webpage and a user interface from a network, for example, the user can set and save a dynamic application scenario for a high-definition movie and a static application scenario for a webpage.

In an embodiment of the disclosure, the play device determines the application scenario corresponding to the contents to be displayed as follows:

The play device can detect the application scenario corresponding to the contents to be displayed according to a selection by a user, for example, the user specifies the contents to be displayed (e.g., a video, a webpage launched and specified by the user, an interface specified by the user, etc.) in a touch or remote control.

In an embodiment of the disclosure, the touch controls includes an input of a finger-touch, an input by a touch pen, etc., and the remote controls includes remote controlling with a remote controller, a mouse, etc.

In an embodiment of the disclosure, a correspondence relationship table between the contents to be displayed and the application scenario corresponding thereto is stored in a memory of the play device.

In an embodiment of the disclosure, the application scenario parameters include but will not be limited to a part or all of the brightness, contrast, chroma, color temperature, sharpness, definition, backlight value, sound volume, sound balance, etc., of the application scenario.

In an embodiment of the disclosure, the application scenario parameters can be preset scenario parameters stored in the device being shipped from a factory. The user can further customize different application scenario parameters later.

In an embodiment of the disclosure, the application scenario parameters of the contents to be displayed fall into but will not be limited to application scenario parameters of a part or all of image data or audio data of the contents to be displayed or Hyper Text Markup Language (HTML) data from a webpage.

In an embodiment of the disclosure, the correspondence relationship table between the application scenario of the contents to be displayed and the application scenario parameters corresponding thereto is stored in the memory of the play device.

In an embodiment of the disclosure, the play device can further identify a control signal (touch or remote control) of the user for the contents to be displayed, e.g., Start, Pause, Forward, End, Return, etc. A correspondence relationship table between the control signals and control contents is also stored in the memory of the play device.

In an embodiment of the disclosure, the play device transmits the determined application scenario parameters of the contents to be displayed, to the display device particularly as follows:

The play device transmits the application scenario parameters of the contents to be displayed, to the display device over the network channel between the play device and the display device. Particularly the play device transmits the application scenario parameters of the contents to be displayed, to the display device in a crafting packet over the network channel between the play device and the display device.

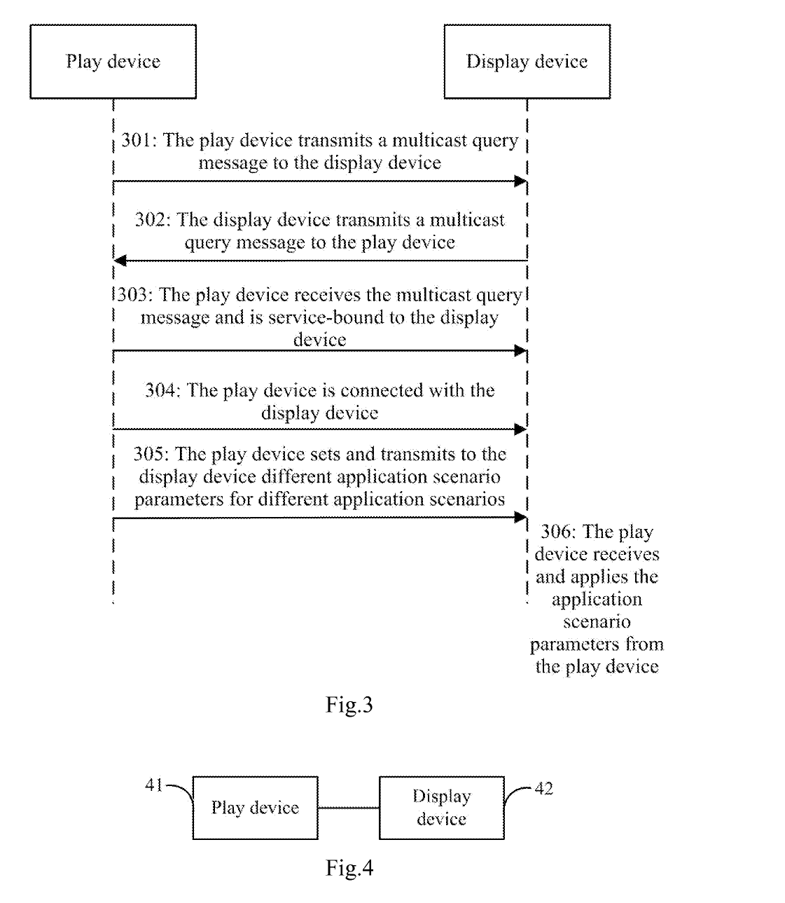

FIG. 3 illustrates a particular flow chart of exchanging information between a play device and a display device over a network channel according to an embodiment of the disclosure.

The network channel in the embodiment of the disclosure can be a wired network connection or a wireless network connection. In an implementation, the play device and the display device can be connected in the same local area network which may not be connected with an external network.

In an embodiment of the disclosure, the wireless network connection includes but will not be limited to Wireless Fidelity (Wi-Fi), Zigbee (short-range wireless communication technology), Bluetooth or another wireless connection; and the wired network connection can be a network connection based on Transmission Control Protocol/Internet Protocol (TCP/IP).

In an embodiment of the disclosure, the play device and the display device, both of which after a system-initialization process in startup, begin to connect with each other over a network.

In an embodiment of the disclosure, the play device and the display device are connected over the network particularly as follows:

The play device transmits a multicast query message to the display device over a control channel to request for being connected with the display device;

The display device transmits a multicast query message to the play device over the control channel upon reception of the multicast query message transmitted from the play device to determine to be connected with the play device; and

The play device receives the multicast query message transmitted over the control channel by the display device, that is, the play device is connected successfully with the display device.

FIG. 3 illustrates a particular flow chart of establishing a network channel between a play device and a display device according to an embodiment of the disclosure.

As illustrated in FIG. 2, a method for adjusting application scenario parameters according to an embodiment of the disclosure includes:

Operation 201: a display device receives application scenario parameters of contents to be displayed, transmitted from a play device; and

Operation 202: the display device adjusts application scenario parameters according to the application scenario parameters of the contents to be displayed.

In this embodiment, the display device receives the application scenario parameters of the contents to be displayed, transmitted from the play device particularly as follows: the display device receives a crafting packet transmitted from the play device over a network channel, decodes the crafting packet and obtains the application scenario parameters of the contents to be displayed.

In an embodiment of the disclosure, the contents to be displayed include but will not be limited to one of a video stored locally on the play device, a multimedia video from an external network, a webpage specified by a user, an interface specified by the user, a text file, etc.

In an embodiment of the disclosure, the contents to be displayed are available from an external network, a local storage of the play device, etc.

In an embodiment of the disclosure, the application scenario parameters of the contents to be displayed, received by the display device include but will not be limited to a part or all of the brightness, contrast, chroma, color temperature, sharpness, definition, backlight value, sound volume, sound balance, etc., of the application scenario.

In an embodiment of the disclosure, the application scenario parameters of the contents to be displayed fall into but will not be limited to application scenario parameters of a part or all of image data or audio data of the contents to be displayed or HTML data from a webpage.

In an embodiment of the disclosure, the display devices adjusts the application scenario parameters according to the application scenario parameters of the contents to be displayed particularly as follows:

The display device replaces the application scenario parameters of the current application scenario with the received application scenario parameters of the contents to be displayed, and the current application scenario parameters are replaced so that the display device can adjust application scenario parameters for different playing contents to thereby greatly lower the distortion of a still picture while the playing contents are switched between a moving picture and the still picture so as to improve the quality of the different playing contents.

In an embodiment of the disclosure, the current displaying contents are available from an external network or an external transmitting device, e.g., a satellite receiver, a cabled TV signal transmitter, a network set-box, etc.

In an embodiment of the disclosure, the application scenario parameters of the current displaying contents can be preset scenario parameters stored in the display device being shipped from a factory. The user can further customize different application scenario parameters later.

In an embodiment of the disclosure, the play device can further identify a control signal (touch or remote control) of the user for the contents to be displayed, e.g., Start, Pause, Forward, End, Return, etc. A correspondence relationship table between the control signals and control contents is also stored in the memory of the play device.

In an embodiment of the disclosure, the display device and the play device exchange information over a network channel; and FIG. 3 illustrates a particular flow chart of exchanging information between a display device and a play device over a network channel.

In an embodiment of the disclosure, the network channel can be a wired network connection or a wireless network connection.

In an implementation, the play device and the display device can be connected in the same local area network which may not be connected with an external network.

In an embodiment of the disclosure, the wireless network connection includes but will not be limited to Wi-Fi, Zigbee, Bluetooth or another wireless connection; and the wired network connection can be a network connection based on TCP/IP.

In an embodiment of the disclosure, before the display device receives the application scenario parameters of the contents to be displayed, transmitted from the play device, the display device needs to be connected with the play device, so that the play device and the display device discover each other and then exchange information.

In an embodiment of the disclosure, the play device and the display device, both after a system-initialization process in startup, begin to connect with each other over a network.

In an embodiment of the disclosure, the play device and the display device are connected over the network particularly as follows:

The play device transmits a multicast query message to the display device over a control channel to request for being connected with the display device;

The display device transmits a multicast query message to the play device over the control channel upon reception of the multicast query message transmitted from the play device to determine to be connected with the play device; and

The play device receives the multicast query message transmitted over the control channel by the display device, that is, the play device is connected successfully with the display device.

FIG. 3 illustrates a particular flow chart of establishing a network channel between a play device and a display device according to an embodiment of the disclosure.

A particular process of establishing a network connection, and exchanging information, over a control channel in a system for adjusting application scenario parameters according to an embodiment of the disclosure will be described below in details with reference to FIG. 3.

In an embodiment of the disclosure, a play device and a display device, both of which are separated, are connected over a network through a control channel generally in the following operations:

In an embodiment of the disclosure, the play device and the display device, both of which after a system-initialization process in startup, begin to connect with each other over a network.

Operation 301: the play device transmits a multicast query message to the display device;

The play device transmits the multicast query message to the display device by transmitting the multicast query message to the display device over a control channel to request for being connected with the display device, where the multicast query message transmitted from the play device carries an Internet Protocol (IP) address, and a serving port number, of the play device, both of which can be identified by the display device.

In an embodiment of the disclosure, the play device can be a set-top box, a network player, a DVD player, a notebook PC, a tablet PC, a smart phone, a video camera, etc.; and the display device generally refers to a TV set.

Operation 302: the display device transmits a multicast query message to the play device.

In an embodiment of the disclosure, the display device transmits the multicast query message to the display device by transmitting the multicast query message to the play device over the control channel upon reception of the multicast query message transmitted from the play device to determine to be connected with the play device.

Where the multicast query message transmitted from the display device carries an IP address, and a serving port number, of the display device; and the display device creates locally a server socket (including a communication protocol, a local protocol address, a local host port, a remote host address, a remote protocol port and other information) upon reception of the multicast query message transmitted from the play device to establish a service connection with the play device for exchanging information, and listen in real time to the serving port to receive another service request.

Operation 303: the play device receives the multicast query message transmitted from the display device and is service-bound to the display device.

In an embodiment of the disclosure, the play device receives the multicast query message by receiving the multicast query message transmitted over the control channel by the display device; and the play device detects whether the service provided by the display device is supported upon reception of the multicast query message transmitted by the display device, and if so, then the play device is service-bound to the display device, and the flow proceeds to the operation 304.

Operation 304: the play device is connected with the display device.

In an embodiment of the disclosure, the play device is connected with the display device by being connected with a serving IP address and a port provided by the display device and creating a socket with the display device to establish the service connection with the play device to thereby exchange information.

The play device and the display device, both of which are separated, exchange information over the control channel to set the application scenario parameters generally in the following operations:

Operation 305: the play device adjusts different application scenario parameters for different application scenarios and transmits the different application scenario parameters to the display device.

Operation 306: the display device receives and applies the different application scenario parameters from the play device.

In an embodiment of the disclosure, the contents to be displayed include but will not be limited to one of a video stored locally on the play device, a multimedia video from an external network, a webpage specified by a user, an interface specified by the user, a text file, etc.

In an embodiment of the disclosure, the scenario parameters include but will not be limited to a part or all of the brightness, contrast, chroma, color temperature, sharpness, definition, backlight value, sound volume, sound balance, etc., of the application scenario.

In an embodiment of the disclosure, the scenario parameters can be preset scenario parameters stored in the device being shipped from a factory. The user can further customize different application scenario parameters later.

In an embodiment of the disclosure, the play device sets the different application scenario parameters for the different application scenarios and transmits the different application scenario parameters to the display device in the operation 305 particularly as follows:

The play device determines an application scenario corresponding to contents to be displayed;

The play device determines application scenario parameters of the contents to be displayed corresponding to the application scenario of the contents to be displayed, according to a correspondence relationship between the application scenario and the application scenario parameters of the contents to be displayed; and

The play device transmits the determined application scenario parameters of the contents to be displayed, to the display device, so that the display device adjusts application scenario parameters according to the application scenario parameters of the contents to be displayed.

In an embodiment of the disclosure, the play device transmits the application scenario parameters of the contents to be displayed, to the display device in a crafting packet over a control channel between the play device and the display device, so that the display device adjusts the application scenario parameters according to the application scenario parameters of the contents to be displayed.

In an embodiment of the disclosure, the display device receives and applies the application scenario parameters from the play device in the operation 306 by receiving and decoding the crafting packet transmitted from the play device and obtaining the application scenario parameters of the contents to be displayed; and adjusting the application scenario parameters according to the received application scenario parameters.

In an embodiment of the disclosure, the display device adjusts the application scenario parameters according to the received application scenario parameters particularly as follows:

The display device replaces the application scenario parameters of the current application scenario with the received application scenario parameters of the contents to be displayed, and the current application scenario parameters are replaced so that the display device can adjust different application scenario parameters for the different playing contents to thereby greatly lower the distortion of a still picture while the playing contents are switched between a moving picture and the still picture so as to improve the quality of the different playing contents.

In an embodiment of the disclosure, the display device exchanges information with the play device over a network channel.

In an embodiment of the disclosure, the play device and the display device can be connected in the same local area network which may not be connected with an external network.

In an embodiment of the disclosure, a wireless network connection includes but will not be limited to Wi-Fi, Zigbee, Bluetooth or another wireless connection; and a wired network connection can be a network connection based on TCP/IP.

For the flows of the methods above, embodiments of the disclosure further provide a system for adjusting application scenario parameters, a play device and a display device, and reference can be made to the implementations of the methods above for configuration details of the system and the devices, so a repeated description thereof will be omitted here.

As illustrated in FIG. 4, an embodiment of the disclosure provides a system for adjusting application scenario parameters, the system including:

A play device 41 is configured to determine an application scenario corresponding to contents to be displayed; to determine application scenario parameters of the contents to be displayed corresponding to the application scenario of the contents to be displayed, according to a correspondence relationship between the application scenario and the application scenario parameters of the contents to be displayed; and to transmit the determined application scenario parameters of the contents to be displayed, to a display device, so that the display device adjusts application scenario parameters according to the application scenario parameters of the contents to be displayed; and

The display device 42 is configured to receive the application scenario parameters of the contents to be displayed, transmitted from the play device; and to adjust the application scenario parameters according to the application scenario parameters of the contents to be displayed.

In an embodiment of the disclosure, the display device exchanges information with the play device over a network control channel.

In an embodiment of the disclosure, the play device and the display device can be connected in the same local area network which may not be connected with an external network.

In an embodiment of the disclosure, a wireless network connection includes but will not be limited to Wi-Fi, Zigbee, Bluetooth or another wireless connection; and a wired network connection can be a network connection based on TCP/IP.

In an embodiment of the disclosure, the play device and the display device, both of which after a system-initialization process in startup, begin to connect with each other over a network.

In an embodiment of the disclosure, the play device and the display device are connected over the network particularly as follows:

The play device transmits a multicast query message to the display device over a control channel to request for being connected with the display device;

The display device transmits a multicast query message to the play device over the control channel upon reception of the multicast query message transmitted from the play device to determine to be connected with the play device; and

The play device receives the multicast query message transmitted over the control channel by the display device, that is, the play device is connected successfully with the display device.

In an embodiment of the disclosure, the play device and the display device are connected over the control channel to enable the play device and the display device to discover each other and then exchange information, so that the play device transmits continuously the application scenario parameters corresponding to the contents to be displayed, to the display device to enable the display device to adjust different application scenario parameters for the different playing contents to thereby greatly lower the distortion of a still picture while the playing contents are switched between a moving picture and the still picture so as to improve the quality of the different playing contents.

The play device and the display device in the system for adjusting application scenario parameters according to this embodiment of the disclosure can be arranged in the same physical equipment or can be embodied as a plurality of separately arranged physical devices.

When the play device and the display device are embodied as a plurality of separately arranged physical devices, the display device can be a TV set, the play device can be a set-top box, a network player, a DVD player, a notebook PC, a tablet PC, a smart phone, a video camera, etc.

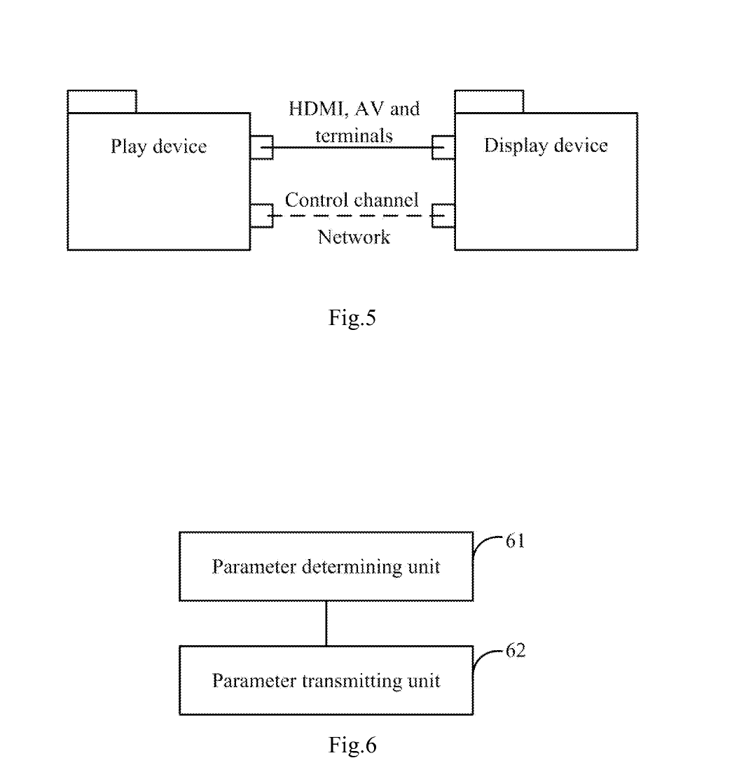

FIG. 5 illustrates a schematic structural diagram of another system for adjusting application scenario parameters according to an embodiment of the disclosure. In FIG. 5, the play device and the display device can further perform bidirectional communication over a line specified by a transmission path, and this is a connection well known in the prior art generally configured to pass video signals of playing contents.

The physical connection in the prior art is typically one of HDMI, an Audio & Video (AV) interface and terminals. Typically a video signal is transmitted when the play device, and the display device, both of which are separated, are connected as such in the prior art. However for the display device, the video signal is input, and the display device will set the current application scenario as the current playing content is video; and when a user interface is handled by the display device as a video, a display effect of the user interface may be degraded, and particularly there may be a significant loss of text information, so that a still picture may tend to be distorted when the playing contents are switched between a moving picture and the still picture, thus lowering the quality of the still picture being played.

The system for adjusting application scenario parameters according to the embodiment of the disclosure as illustrated in FIG. 5 can address the drawback above in the prior art. The system according to this embodiment of the disclosure as illustrated in FIG. 5 can further include a network protocol compliant control channel over which the display device exchanges information with the play device; the play device determines an application scenario corresponding to contents to be displayed; determines application scenario parameters of the contents to be displayed corresponding to the application scenario of the contents to be displayed, according to a correspondence relationship between the application scenario and the application scenario parameters of the contents to be displayed; and transmits continuously the determined application scenario parameters of the contents to be played, to the display device over the network channel, and the display device adjusts application scenario parameters according to the received application scenario parameters to replace the current application scenario parameters, so that the display device can adjust different application scenario parameters for the different playing contents to thereby greatly lower the distortion of a still picture while the playing contents are switched between a moving picture and the still picture so as to improve the quality of the different playing contents.

In an embodiment of the disclosure, the play device and the display device can be connected in the same local area network which may not be connected with an external network.

In an embodiment of the disclosure, a wireless network connection includes but will not be limited to Wi-Fi, Zigbee, Bluetooth or another wireless connection; and a wired network connection can be a network connection based on TCP/IP.

As illustrated in FIG. 6, it is provided a play device in a system for adjusting application scenario parameters according to an embodiment of the disclosure, the play device including:

A parameter determining unit 61 is configured to determine an application scenario corresponding to contents to be displayed; and to determine application scenario parameters of the contents to be displayed corresponding to the application scenario of the contents to be displayed, according to a correspondence relationship between the application scenario and the application scenario parameters of the contents to be displayed; and

A parameter transmitting unit 62 is configured to transmit the determined application scenario parameters of the contents to be displayed, to a display device, so that the display device adjusts application scenario parameters according to the application scenario parameters of the contents to be displayed.

The units above may be some computer readable program instructions stored in a memory, and once the computer readable program instructions were implemented by one or more processors, the functions of the units will come true. The one or more processors and memory may refer to related content in FIG. 8.

The parameter transmitting unit 62 is configured:

To transmit the application scenario parameters of the contents to be displayed, to the display device in a crafting packet over a control channel between the play device and the display device.

In an embodiment of the disclosure, the control channel is a network channel between the play device and the display device.

In an embodiment of the disclosure, the play device and the display device, both of which after a system-initialization process in startup, begin to connect with each other over a network.

In an embodiment of the disclosure, the play device and the display device can be connected in the same local area network which may not be connected with an external network.

In an embodiment of the disclosure, a wireless network connection includes but will not be limited to Wi-Fi, Zigbee, Bluetooth or another wireless connection; and a wired network connection can be a network connection based on TCP/IP.

Moreover the play device according to the embodiment of the disclosure as illustrated in FIG. 5 can further perform bidirectional communication with the display device over a line specified by a transmission path, and the physical connection in the prior art is typically one of HDMI, an AV interface and terminals in FIG. 5. Typically a video signal is transmitted when the play device, and the display device, both of which are separated, are connected as such in the prior art. The play device according to the embodiment of the disclosure as illustrated in FIG. 5 can also be physically connected as in the prior art to transmit a video signal of contents to be displayed, to the display device over the line specified by the transmission path.

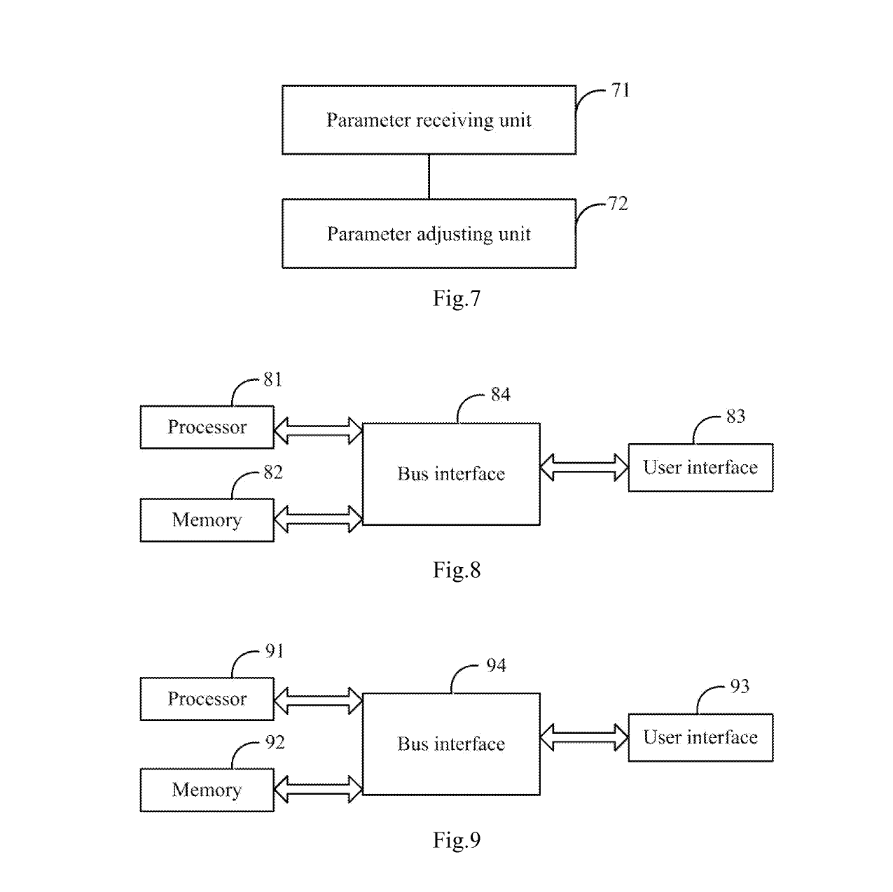

As illustrated in FIG. 7, it is provided a display device in a system for adjusting application scenario parameters according to an embodiment of the disclosure, the display device including:

A parameter receiving unit 71 is configured to receive application scenario parameters of contents to be displayed, transmitted from a play device; and

A parameter adjusting unit 72 is configured to adjust application scenario parameters according to the application scenario parameters of the contents to be displayed.

The units above may be some computer readable program instructions stored in a memory, and once the computer readable program instructions were implemented by one or more processors, the functions of the units will come true. The one or more processors and memory may refer to related content in FIG. 9.

The parameter receiving unit 71 is configured:

To receive and decode a crafting packet transmitted from the play device and to obtain the application scenario parameters of the contents to be displayed.

The parameter adjusting unit 72 is configured:

To replace application scenario parameters of the current application scenario with the received application scenario parameters of the contents to be displayed.

In an embodiment of the disclosure, the display devices receive the application scenario parameters of the contents to be displayed, transmitted from the play device over a control channel between the play device and the display device.

In an embodiment of the disclosure, the control channel is a network channel between the play device and the display device.

In an embodiment of the disclosure, the play device and the display device, both after a system-initialization process in startup, begin to connect with each other over a network.

In an embodiment of the disclosure, the play device and the display device can be connected in the same local area network which may not be connected with an external network.

In an embodiment of the disclosure, a wireless network connection includes but will not be limited to Wi-Fi, Zigbee, Bluetooth or another wireless connection; and a wired network connection can be a network connection based on TCP/IP.

Moreover the play device according to the embodiment of the disclosure as illustrated in FIG. 5 can further perform bidirectional communication with the display device over a line specified by a transmission path, and the physical connection in the prior art is typically one of HDMI, an AV interface and terminals in FIG. 5. Typically a video signal is transmitted when the play device, and the display device, both of which are separated, are connected as such in the prior art. The play device according to the embodiment of the disclosure as illustrated in FIG. 5 can also be physically connected as in the prior art to transmit a video signal of contents to be played, to the display device over the line specified by the transmission path.

As illustrated in FIG. 8, it is provided a play device in a system for adjusting application scenario parameters according to an embodiment of the disclosure, the play device including a processor 81, a memory 82, a user interface 83 and a bus interface 84, where the processor 81, the memory 82 and the user interface 83 are connected via the bus interface 84.

The processor 81 is configured to determine an application scenario corresponding to contents to be displayed; to determine application scenario parameters of the contents to be displayed corresponding to the application scenario of the contents to be displayed, according to a correspondence relationship between the application scenario of the contents to be displayed and the application scenario parameters of the contents to be displayed; and to transmit the determined application scenario parameters of the contents to be displayed, to a display device, so that the display device adjusts application scenario parameters according to the application scenario parameters of the contents to be displayed.

The processor 81 is further configured to transmit the application scenario parameters of the contents to be displayed, to the display device in a crafting packet over a control channel between the play device and the display device.

The processor 81 is further configured to begin to be connected with the display device over a network after a system-initialization process in startup of the play device.

The processor 81 is further configured for the play device to be physically connected with the display device via one of HDMI, an AV interface and terminals and to transmit a video signal of the contents to be played, to the display device over a line specified by a transmission path.

In the embodiment of the disclosure in FIG. 8, the bus architecture can include any number of interconnected buses and bridges and particularly link together one or more processors represented by the processor 81, one or more memories represented by the memory 82, and various other circuits. The bus architecture can further link together various other circuits, e.g., peripheral devices, a voltage stabilizer, a power management circuit, etc., and all these circuits are well known in the art, so a further description thereof will be omitted in this context.

In the embodiment of the disclosure in FIG. 8, the bus interface 84 serves as an interface, and the bus interface 84 includes a communication interface for the play device and the display device to be connected over the network and also an interface for the play device and the display device to be physically connected (one of HDMI, an AV interface and terminals) for bidirectional communication. The processor 81 is responsible for managing the bus architecture and performing normal processes. The memory 82 can store data used by the processor 81 to perform the operations. For different user devices, the user interface 83 can also be an interface connected with an internal or external device as needed, and the connected device can include but will not be limited to a keypad, a display, a speaker, a microphone, a joy stick, etc.

As illustrated in FIG. 9, it is provided a display device in a system for adjusting application scenario parameters according to an embodiment of the disclosure, the display device including a processor 91, a memory 92, a user interface 93 and a bus interface 94, where the processor 91, the memory 92 and the user interface 93 are connected via the bus interface 94.

The processor 91 is configured to receive application scenario parameters of contents to be displayed, transmitted from a play device; and to adjust application scenario parameters according to the application scenario parameters of the contents to be displayed.

The processor 91 is further configured to receive and decode a crafting packet transmitted from the play device and to obtain the application scenario parameters of the contents to be displayed; and to replace the application scenario parameters of the current application scenario with the received application scenario parameters of the contents to be displayed.

The processor 91 is further configured to begin to be connected with the play device over a network after a system-initialization process in startup of the display device.

The processor 91 is further configured for the display device to be physically connected with the play device via one of HDMI, an AV interface and terminals and to receive a video signal of the contents to be played, from the play device over a line specified by a transmission path.

In the embodiment of the disclosure in FIG. 9, the bus architecture can include any number of interconnected buses and bridges and particularly link together one or more processors represented by the processor 91, one or more memories represented by the memory 92, and various other circuits. The bus architecture can further link together various other circuits, e.g., peripheral devices, a voltage stabilizer, a power management circuit, etc., and all these circuits are well known in the art, so a further description thereof will be omitted in this context.

In the embodiment of the disclosure in FIG. 9, the bus interface 94 serves as an interface, and the bus interface 94 includes a communication interface for the play device and the display device to be connected over the network and also an interface for the play device and the display device to be physically connected (one of HDMI, an AV interface and terminals) for bidirectional communication. The processor 91 is responsible for managing the bus architecture and performing normal processes. The memory 92 can store data used by the processor 91 to perform the operations. For different user devices, the user interface 93 can also be an interface connected with an internal or external device as needed, and the connected device can include but will not be limited to a keypad, a display, a speaker, a microphone, a joy stick, etc.

In the embodiments of the disclosure, the play device determines an application scenario corresponding to contents to be displayed; determines application scenario parameters of the contents to be displayed corresponding to the application scenario of the contents to be displayed, according to a correspondence relationship between the application scenario and the application scenario parameters of the contents to be displayed; and transmits the determined application scenario parameters of the contents to be displayed, to the display device over the network channel between the play device and the display device, and the display device adjusts application scenario parameters according to the received application scenario parameters to replace the current application scenario parameters, so that the display device can adjust different application scenario parameters for different playing contents to thereby greatly lower the distortion of a still picture while the playing contents are switched between a moving picture and the still picture so as to improve the quality of the different playing contents.

Those skilled in the art shall appreciate that the embodiments of the disclosure can be embodied as a method, a system or a computer program product. Therefore the disclosure can be embodied in the form of an all-hardware embodiment, an all-software embodiment or an embodiment of software and hardware in combination. Furthermore the disclosure can be embodied in the form of a computer program product embodied in one or more computer useable storage mediums (including but not limited to a disk memory, a CD-ROM, an optical memory, etc.) in which computer useable program codes are contained.

The disclosure has been described in a flow chart and/or a block diagram of the method, the device (system) and the computer program product according to the embodiments of the disclosure. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow chart and/or the block(s) of the block diagram.

Although the preferred embodiments of the disclosure have been described, those skilled in the art benefiting from the underlying inventive concept can make additional modifications and variations to these embodiments. Therefore the appended claims are intended to be construed as encompassing the preferred embodiments and all the modifications and variations coming into the scope of the disclosure.

Evidently those skilled in the art can make various modifications and variations to the disclosure without departing from the spirit and scope of the disclosure. Thus the disclosure is also intended to encompass these modifications and variations thereto so long as the modifications and variations come into the scope of the claims appended to the disclosure and their equivalents.

1. A method for adjusting application scenario parameters, wherein the method comprises:
determining, by a play device, an application scenario corresponding to contents to be displayed;
determining, by the play device, according to a correspondence relationship between the application scenario of the contents to be displayed and application scenario parameters of the contents to be displayed, the application scenario parameters of the contents to be displayed; and
transmitting, by the play device, the determined application scenario parameters of the contents to be displayed, to a display device, so that the display device adjusts application scenario parameters according to the application scenario parameters of the contents to be displayed.

2. The method according to claim 1, wherein the contents to be displayed comprise one of:
a video stored locally in the play device, a multimedia video from a network, a User Interface (UI), a text file and a webpage.

3. The method according to claim 1, wherein transmitting, by the play device, the determined application scenario parameters of the contents to be displayed, to the display device comprises:
transmitting, by the play device, the application scenario parameters of the contents to be displayed, to the display device over a network channel between the play device and the display device.

4. A method for adjusting application scenario parameters, wherein the method comprises:
receiving, by a display device, application scenario parameters of contents to be displayed, transmitted from a play device; and
adjusting, by the display device, application scenario parameters according to the application scenario parameters of the contents to be displayed.

5. The method according to claim 4, wherein the contents to be displayed comprise one of:
a video stored locally in the play device, a multimedia video from a network, a User Interface (UI), a text file and a webpage.

6. The method according to claim 4, wherein receiving, by a display device, application scenario parameters of contents to be displayed, transmitted from a play device comprises:
receiving, by the play device, the application scenario parameters of contents to be displayed, transmitted from a play device over a network channel between the play device and the display device.

7. The method according to claim 4, wherein adjusting, by the display device, the application scenario parameters according to the application scenario parameters of the contents to be displayed, comprises:
replacing, by the display device, application scenario parameters of current application scenario with the received application scenario parameters of the contents to be displayed.

8. A play device, wherein the play device comprises:
one or more processors;
and
a memory;
wherein the memory stores one or more computer readable program codes that, when executed, cause the one or more processors to:
determine an application scenario corresponding to contents to be displayed;
determine according to a correspondence relationship between the application scenario of the contents to be displayed and application scenario parameters of the contents to be displayed, the application scenario parameters of the contents to be displayed; and
transmit the determined application scenario parameters of the contents to be displayed, to a display device, so that the display device adjusts application scenario parameters according to the application scenario parameters of the contents to be displayed.

9. The play device according to claim 8, wherein the contents to be displayed comprise one of:
a video stored locally in the play device, a multimedia video from a network, a User Interface (UI), a text file and a webpage.

10. The play device according to claim 8, wherein the one or more computer readable program codes, when executed, cause the one or more processors to:
transmit the application scenario parameters of the contents to be displayed, to the display device over a network channel between the play device and the display device.

11. A display device, wherein the display device comprises:
one or more processors;
and
a memory;
wherein the memory stores one or more computer readable program codes that, when executed, cause the one or more processors to:
receive application scenario parameters of contents to be displayed, transmitted from a play device; and
adjust application scenario parameters according to the application scenario parameters of the contents to be displayed.

12. The display device according to claim 11, wherein the contents to be displayed comprise one of:
a video stored locally in the play device, a multimedia video from a network, a User Interface (UI), a text file and a webpage.

13. The display device according to claim 11, wherein the one or more computer readable program codes, when executed, cause the one or more processors to:
receive application scenario parameters of contents to be displayed, transmitted from a play device over a network channel between the play device and the display device.

14. The display device according to claim 11, wherein the one or more computer readable program codes, when executed, cause the one or more processors to:
replace application scenario parameters of current application scenario with the received application scenario parameters.
